(19) United States
(12) Patent Application Publication
(10) Pub. No.: US 2024/0311684 A1
(43) Pub. Date: Sep. 19, 2024

(54) ARTIFICIAL INTELLIGENCE-BASED GAMIFICATION FOR SERVICE BACKGROUND

(71) Applicant: Siemens Healthineers AG, Forchheim (DE)

(72) Inventors: Vivek Singh, Princeton, NJ (US); Dorin Comaniciu, Princeton, NJ (US); Ankur Kapoor, Plainsboro, NJ (US); Bogdan Georgescu, Princeton, NJ (US); Poikavila Ullaskrishnan, Lebanon, NH (US); Michael Wendt, Roswell, GA (US); Neil Biehn, Durham, NC (US); Sarith Mohan, Apex, NC (US)

(21) Appl. No.: 18/184,700

(22) Filed: Mar. 16, 2023

(51) Int. Cl. G06N 20/00

(52) U.S. Cl. CPC G06N 20/00

(57) ABSTRACT

For AI-based recommendations in a service management system, the AI is machine trained using gamification. A model of the service management system is used in simulation to train a policy in reinforcement learning to implement strategies for improvement of KPI(s). By varying sampling of distribution of parameters of the model and/or varying the distributions of parameters used in the model, the policy learns to deal with a variety of situations using the simulations from the model. The resulting AI (machine-learned policy) is used to make recommendations for the service management system.

### BACKGROUND

The present embodiments relate to computer-based solutions for service management. Service management is traditionally, and largely still, driven by manual processes. Operations have been digitized, making relevant data more readily accessible. This digitization has also led to an active development of artificial intelligence (AI)-based tools, especially in field service operations as well as ingestion of machine data for maintenance. Most efforts have been focused on modeling the service data as a time series data stream and application of AI algorithms to detect anomalies, which are subsequently reviewed by traditional manual processes. The complexity arises due to the dynamic and adverse nature of the service environment with data from multitude of sources and also due to short verses long term effects of various patterns. Due to the complexity involved in management of service operations (e.g., management of human resources), artificial intelligence use is generally limited to predictive or preventive maintenance solutions or providing intelligent field services. The impact of AI is limited with respect to long-term key performance indicators (KPIs) (e.g., customer satisfaction, employee satisfaction, overhead costs, etc.) when it comes to overall management of service operations, which involve strategic planning of inventory as well resources. While such use of AI facilitates early identification of field problems, it doesn't offer solutions on how to mitigate the field problems.

Efforts have also been made to build a digital twin of the service organization, which is a digital representation of the data flow between various entities in the model. This is often focused on addressing the supply chain management, one particular aspect of service management. Existing solutions are generally focused on use of operation research (OR)-based tools, or via simulations using digital twins. However, OR-based solutions suffer from the risk of considering short term KPIs by only considering average forecast and does not consider the uncertainty of the data measurements. The simulations-based method are used to evaluate certain strategies thought out by experts, as opposed to presenting a strategy itself. Furthermore, there is still a significant involvement of experts to continuously assess the output (recommendations) from these models and figure out an implementation plan. The reason for this is 2-fold—in practice, strategical changes involving human resources are often made gradually to ease adoption and reduce any undesirable effects. As the recommendations are implemented at a steady pace, the original state of the service organization based on which the initial recommendations were made is likely to have already changed, thus, prompting an expert to trigger re-assessing the recommendations.

### SUMMARY

By way of introduction, the preferred embodiments described below include methods, systems, instructions, and non-transitory computer readable media for AI-based recommendations in a service management system. The AI is machine trained using gamification. A model of the service management system is used in simulation to train a policy in reinforcement learning to implement strategies for improvement of KPI(s). By varying sampling of distribution of parameters of the model and/or varying the distributions of parameters used in the model, the policy learns to deal with a variety of situations using the simulations from the model. The resulting AI (machine-learned policy) is used to make recommendations for the service management system.

In a first aspect, a method is provided for machine training an artificial intelligence to make recommendations in a service management system. The service management system is modeled. The model includes machines, locations of the machines, service personnel, locations of the service personnel, and service times. A processor machine trains the artificial intelligence with reinforcement learning. The artificial intelligence is trained to make the recommendations for service by the service personnel of the machines based on simulations from the modeling of the service system and based on rewards from a performance indicator from the service times. A policy of the artificial intelligence as trained by the machine training is stored.

In one implementation, the modeling includes modeling with a distribution of the service times based, at least in part, on travel times. The machine training includes simulating using different samples from the distribution for the simulations and/or variance of the distribution.

In another implementation, the machine training includes machine training with an adversarial machine-learned agent configured by past training to perturb values of parameters of the model in the simulations such that an adverse reward is received for the adversarial machine-learned agent where the artificial intelligence fails to improve the rewards for the artificial intelligence.

As another implementation, the modeling includes representing the service management system as a random process defined over states of the machines, locations of the machines, service personnel, locations of the service personnel, and the service times with state transition functions defining probabilities of change in the states. For example, the states and the state transition functions are refined based on matching observations from the modeling of the service management system to observations from the service management system. As a further example, the refining is based on actions and resulting values of the performance indicator.

According to another implementation, the machine training includes estimating states, taking actions, and receiving the rewards based on the simulations.

In one implementation, the reinforcement learning uses perturbation of the modeling in the simulations. The perturbations are for different initial conditions and/or state transitions.

In a further implementation, the model is updated with statistical testing of the service times and/or other parameters of the model.

As a further implementation, the policy of the artificial intelligence is retrained when an actual distribution of a parameter of the model is a threshold difference from a distribution or distributions used in the machine training.

As yet a further implementation, the policy of the artificial intelligence is retrained based on review results for the recommendations by a service manager.

In a second aspect, a method is provided for machine training an artificial intelligence to make recommendations in a service management system. The service management system is modeled using a model with state parameters and state transition parameters for the service management system. A processor machine trained a policy with reinforcement learning. The policy is trained to make the recommendations based on simulations using the model. The simulations perturb sampling of distributions and/or selection of distributions for the state parameters and/or the state transition parameters. The policy as trained by the machine training is stored.

In an implementation, the modeling includes modeling with the state parameters comprising including machines, locations of the machines, service personnel, locations of the service personnel and the state transition parameters comprising service times and travel times. The machine training includes the reinforcement learning using rewards from performance indicators for the service times and the travel times.

As one implementation, the machine training includes machine training with an adversarial machine-learned agent configured by past training to perturb values of the state parameters and/or the state transition parameters of the model in the simulations such that an adverse reward is received where the policy fails to improve rewards of the reinforcement learning.

As a further implementation, the model is updated with statistical testing the state transition parameters of the model and/or with replacement of values of the state parameters.

In a third aspect, a system is provided for machine-learned model service assistance. A memory is configured to store a policy of the machine-learned model. The policy was learned by reinforcement machine learning in a gamification using simulation of a service environment in combination with the reinforcement machine learning of the policy. A processor is configured to input measurements from the service environment to the policy and to output a recommendation from the policy in response to the input of the measurements. A display is configured to display the recommendation from the policy.

As an implementation, the policy was learned using rewards based on a key performance indicator of the service environment. The display of the recommendation includes an expected value of the key performance indicator given the recommendation and a period for the expected value.

According to another implementation, the policy was learned using rewards based on a key performance indicator of the service environment. The display of the recommendation includes display of a value of the key performance indicator with no change and a value of the key performance indicator when the recommendation is followed.

In one implementation, the processor is configured to adapt the display of the recommendation with a priority based on frequency of assessment of results by a service manager.

In yet another implementation, the gamification included use of the simulation with a model fit to the service environment. The simulations used perturbation of distributions and/or sampling of parameters of the model as fit to the service environment and resulting changes in performance indicators as rewards in the reinforcement machine learning.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a representation of an example service management system or user interface for service management;

FIG. 2 is a flow chart diagram of one implementation of a method for machine training an artificial intelligence to make recommendations in a service management system;

FIG. 3 is a flow chart diagram of gamification for a service environment according to one implementation;

FIG. 4 is a flow chart diagram of an implementation of fitting a model of service management system;

FIG. 5 illustrates an example of machine learning a policy using simulation;

FIG. 6 illustrates an example agent in reinforcement learning in a service environment;

FIG. 7 illustrates an example neural network for a policy in a service environment;

FIG. 8 is a flow chart diagram of one implementation for update of a model of a service management system;

FIG. 9 is a flow chart diagram of an implementation for update of a policy of artificial intelligence for service management recommendations;

FIG. 10 illustrates an example display for feedback from service managers; and

FIG. 11 is a block diagram of a system for machine-learned model service assistance, according to one implementation.

### DETAILED DESCRIPTION OF THE DRAWINGS

An AI-based solution provides for end-to-end optimization of service management. The AI-based solution can handle dynamic, adverse conditions due to ingesting complex service data as part of training and provides recommendations to optimize the service management over any period, such as over one or more months or a quarter.

An AI-powered gamification approach is applied to service management. The AI agent is trained to control the evolution of the physical world to optimize long term KPIs measured over a period. In the context of service management, recommendations are made on, but not limited to, personnel field assignment and their schedules, inventory management, route planning, etc., while ensuring high customer as well as employee satisfaction and keeping the overhead costs low. To develop such an AI, a world model (i.e., a digital model) of the service organization and infrastructure is developed. The AI is trained by practicing control strategies in a massive set of scenarios, played out as if in a game. Rather than training the AI agent to play games such as chess or Go, the AI agent is trained to deal with the dynamic nature of service management using the digital model.

The AI may use one or more of various aspects. AI-powered gamification handles the service management problem. A robust AI agent adapts and works along with the service manager to achieve the target KPIs. An adversarial bot may facilitate more robust learning to realistic real-world perturbations in conjunction with massive simulation used in training. The training of the AI agent is not static but adjusts and adapts to the changes in the physical world. In other words, training does not rely on a stationary model of the world but has the ability to adapt to non-stationary aspects. As opposed to OR-based optimization solutions, this AI-based method handles dynamic, adverse conditions as the training learns with billions of scenarios.

The service manager is presented with recommendations and/or related information that may improve one or more KPIs. KPIs may be forecasted over a long period, such as several weeks, a month, or a quarter due to the simulation model used in training. By playing out likely scenarios in the simulation as part of gamification, the impact of the recommendations on the forecasted KPIs may have a non-linear shape of the forecasted range. The resulting recommendations, if implemented, may result in the KPIs following forecasted curves over an extended period. Confidence information may be provided, such as forecasting the KPI curves over time with a confidence band.

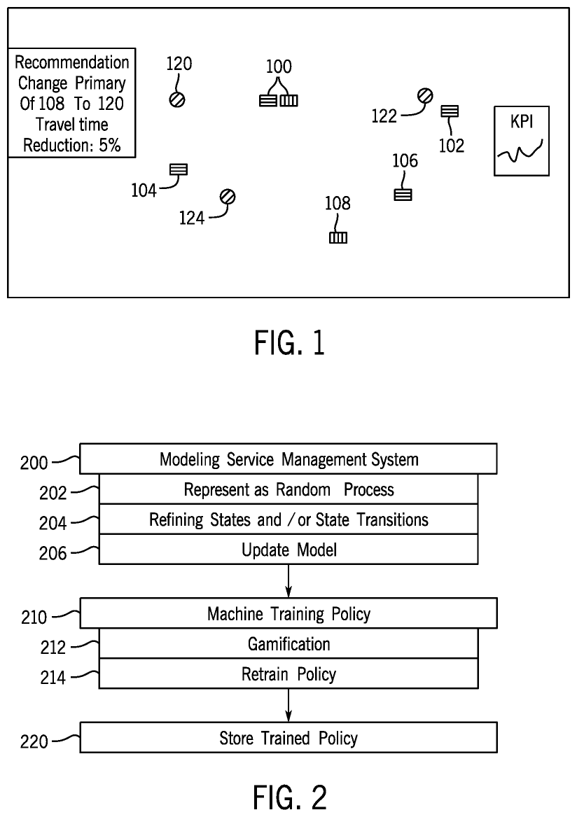

The AI is provided for making recommendations in any of various service management systems. FIG. 1 shows one example. A plurality of different systems or machines are located at different facilities. In this example, machines 100, 102, 104, and 106 represent one type of machine, such as computed tomography (CT) medical systems, at different locations on a map (e.g., a map of a state or service region). Machines 100 and 108 represent another type of machine, such as magnetic resonance imaging (MRI) medical systems, at other locations on the map. At one location, two different types of machines 100 are provided. Service personnel 120, 122, 124 are homed at different locations on the map. A road network connects the locations. Different service personnel 120, 122, 124 have different capabilities, such as service personnel 120 and 122 being trained and/or contracted to service both CT and MR medical scanners (machines 100, 102, 104, 106, and 108). Another service person 124 is trained and/or contracted on CT machines 100, 102, 104, and 106 but not MR machines 100, 108. Additional, different, or fewer types, numbers, and/or locations may be provided. Each item (e.g., location, person, and machine) may have any number of state parameters associated with them, such as working hours, transportation availability, satisfaction rating, % downtime, or any other factor that may affect service. Each parameter is assigned a value (e.g., trained “y/n” for a given type of machine, mean customer satisfaction rating, and/or years of experience) or a distribution of values (e.g., Gaussian distribution for time to repair a machine once at the location of the machine and/or distribution of customer satisfaction).

Changes in state occur. The model includes parameters for the change or transition in state, such as parameters for service time and travel time (e.g., Gaussian distribution for travel time between locations). Service time may be from when dispatched or from when arrived at the machine. The change may be caused or represent various factors, such as weather, vacation time, rerouting/construction, and/or part availability). The transition in state functions may be represented by probabilities for the change to occur, either as values or as distribution of probabilities. Latency in change may be modeled. Uncertainty in change may be modeled.

In this example, different personnel 120, 122, 124 are assigned as primary, secondary, and tertiary by machine 100-108, such as machines 100 (e.g., CT and MR) having service technician 120 as primary and service technician 122 as secondary and machine 104 having a primary of technician 124, secondary of technician 120, and tertiary of technician 122. Any number of personnel 120-124 may be assigned to any given machine. In this context, the recommendations are for this priority of assignment. In other implementations, the recommendations may be for sending personnel when maintenance is required, for assigning by shift, inventory management, or other goals or actions.

While this example is service to repair and/or preventively maintain, other service management environments may be provided, such as delivery or consultation.

The service manager is responsible for keeping the personnel happy, keeping the customers happy, and operating the service efficiently (e.g., reducing costs and repair time). Performance indicators may be used to represent performance of one or more of these goals. For example, one key performance indicator (KPI) is a “wall clock” (i.e., average time to repair from reporting of a problem). The example of FIG. 1 shows KPI for the overall service management system over time, with the KPI increasing (getting worse). Other key performance indicators may be used. Any number of performance indicators may be used. The goal is for the AI to make a recommendation or series of recommendations to improve one, more, or all KPIs. In this example, the recommendation would be to change the technician 120-124 assigned as the primary, secondary, and/or tertiary of any one or more of the machines 100-108, such as a recommendation to change the primary person for machine 108 to technician 120 (e.g., instead of person 122).

Gamification is used to train an artificial intelligence to make recommendations. Once trained, the artificial intelligence may be used to make recommendations with respect to previously unseen or unrecorded situations in the service management system or environment.

FIG. 2 shows one embodiment of a method for machine training an artificial intelligence to make recommendations in a service management system. A machine-learned model is trained to make recommendations, such as primary, secondary, and tertiary assignments of service personnel with respect to different medical imaging machines for a service region. The training uses a combination of simulation of the service management system and strategy for decision making given observed events and/or measurements. This combination is gamification for end-to-end personnel assignment in a service environment.

A computer or processor performs acts 200 and 210. A memory, in interaction with the processor or computer, performs act 220. A same or different computer or processor uses the trained policy to make recommendations. For example, different service managers for different regions use copies of a same policy as machine trained for recommendations for their region based on input of observations and/or measurements for their region.

The acts are performed in the order shown (e.g., top to bottom or numerical) or other orders. Additional, different, or fewer acts may be provided. For example, acts 202, 204, 206, 212, and/or 214 are not used or provided. As another example, an act for using the trained policy to make recommendations is provided.

In act 200, the processor models the service management system. The modeling uses a digital twin of the service management system at any level of generality. The model is used in gamification for stochastic simulation of the service environment in combination with the artificial intelligence provision of strategy or decision-making.

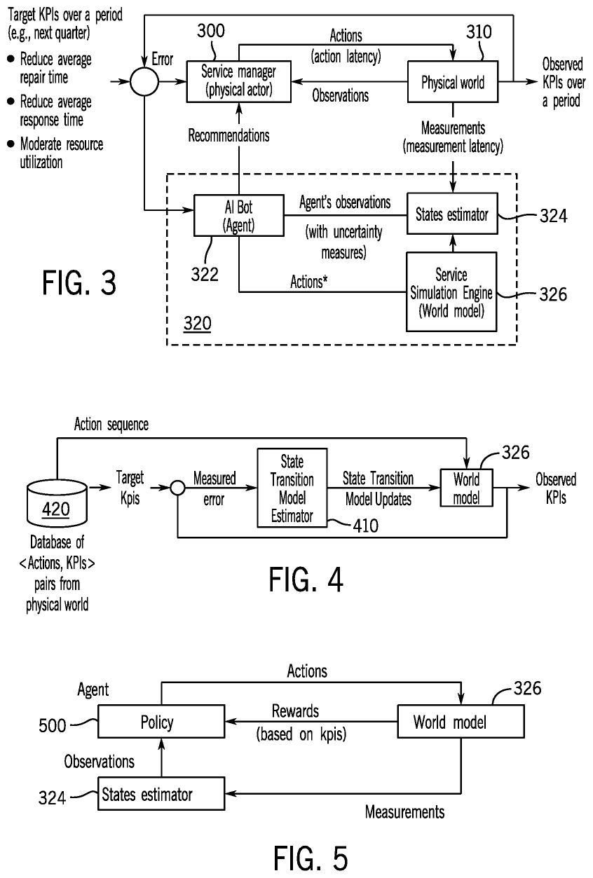

FIG. 3 shows an example AI powered gamification workflow for service management. A processor implemented gamification system 320 uses AI agent 322 interaction with the “world” model 326 to determine the states by the state estimator 324. The “world” model 326 represents the actual or physical world 310 as a digital twin. The world model 326 is fit to emulate or simulate the physical world 310. AI-powered gamification 320 is provided for the service environment.

The service manager 300 makes observations (e.g., KPI, customer feedback, and/or measurements of the physical world 310) and takes actions that impact the physical world 310. The actions/decisions are often driven by making a best effort to optimize the KPIs such as reducing the average response and/or repair time, which positively correlates with customer satisfaction, or keeping the resource utilization at a moderate scale. In AI powered gamification, the service manager 300 is supported by an AI bot/agent 322 that presents recommendations to the manager 300 based on its own estimate of the state of the physical world 310 by the states estimator 324 and knowledge stored based on its past experiences from a massive number of simulations (i.e., the learned AI agent 322). For simulation, the state estimator 324 estimates states based on measurements from the physical world 310 or simulation perturbation through the world model 326. The state estimator 324 generates observations from the measurements and/or world model 326. Actions from the AI agent 322 are provided to the service simulation engine (world model) 326.

The world model 326 is a model with state parameters and state transition parameters for the service management system. For example, the state parameters include the machines 100-108, locations of the machines 100-108, service personnel 120-124, locations of the service personnel, and/or characteristics (e.g., training or contracting for personnel). Other state parameters include service personnel shift (1^{st}, 2^{nd}, or 3^{rd} shift), service agreement information (e.g., contractual details of the service agreement such as preferred service period), or other variables representing the service management. As another example, the state transition parameters include the service times and/or travel times.

Additional, different, or fewer state and/or state transition parameters may be used. For example, the state transition parameters may be functions using probabilities for occurrence (e.g., uncertainty of measurement). Any value, function, or parameter of the world model 326 may be represented by a single value (e.g., mean, median, or measured value), a distribution (e.g., range of values and probability of occurrence for each), a probability, and/or other representation. As one example, the service time for the system, a particular technician, and/or particular machine is represented by a distribution of times. The service time may be from departing (e.g., technician leaving the technician location). In other words, the service time includes both the travel time and the time to fix from arrival. Other times may be used, such as separately tracking service time and travel time. In other examples, the service time is from arrival at the machine to completion of service. Machines or types of machines may have transition parameters as some machines may take longer to repair than others. Latency may be included as a state transition parameter. Other digital twins or models for service environments may be used.

In act 202, the service management system is represented by the world model 326 as a random process defined over states of the machines 100-108, locations of the machines 100-108, service personnel 120-124, locations of the service personnel, and the service times with state transition functions defining probabilities of change in the states. Other parameters may be used for this stochastic representation.

In act 204, the states and state transition functions of the model are fit to the physical world 310 (e.g., measurements and/or observations from the physical world 310). The states and the state transition functions are refined based on matching observations from the modeling of the service management system to observations from the service management system. The actions and resulting value or values for the performance indicator or indicators are used to refine so that the measurements and observations generated by the world model 326 match the physical world 310.

Observations are measurements or derived information tracked by managers or selected as a subset. Observations may include performance indicators. Measurements are values for tracked variables in the service management system. Measurements may include latency.

To train the AI bot/agent 322 to make useful recommendations, the simulation environment (world model 326) is built, similar to an AI gym in gaming. The world model 326 allows the AI agent 322 to take actions and receive feedback from the environment based on how the actions affect the service environment over time. Building such a simulation environment for service industry is challenging due to the complex state representation as well as it's dynamic nature. Thus, the world model 326 is represented as a random process defined over the state of all the physical entities and dynamics defined via the state transition functions (e.g., probability of change).

To manage the model complexity, the state representation as well as state transition functions (i.e., world model parameters) are refined until the reality gap between the forecasted observations based on the world model 326 and observed or measured data is statistically small. To scale up simulation development, the goal is not to the create the most accurate representation of the physical world 310 to its minute details, but a “good-enough” representation that captures key events and states for the KPIs. Multi-scale distributions are extracted from historical data to generalize blocks of details.

FIG. 4 shows the process workflow to estimate the world model 326. A database of action and KPI value pairs from the physical world 310 are used. This database provides target KPI values given actions or action sequence. In an iterative optimization, an error between the target or known KPI value and the estimate or predicated KPI value from the world model 326 given the action is found. This measured error in input to the state transition model estimator 410, which provides updates to the state and state transition parameter values of the world model 326 based on optimization. Iterative optimization of the world model 326 may be done by data science experts working in the service sector with previously known transition functions or using AI by modeling the world model 326 as a generative sequence prediction task and training using spatio-temporal generative training algorithms.

Referring again to FIG. 2, the processor updates the world model 326 in act 206. The physical world 310 of the service environment may change, such as by retirement or quitting of technicians 120-124, change in locations, adding roads, new equipment for service, and/or other alterations. The world model 326 is monitored continuously or periodically to make sure the fit is accurate despite changes. Where a threshold or sufficient change occurs, the world model 326 may be updated with further fitting through optimization (e.g., updating the state transition parameters (e.g., functions) and/or replacement of values of state parameters).

In one implementation, statistical testing, such as testing the service time statistics or other parameters of the model, is used to update. The world model 326 is updated with statistical testing. The physical world 310 is changing dynamically, and hence the world model 326 may also need to be updated. There are multiple aspects of the physical world 310 that are changing. The state of the entities such as customer, employee, etc. may change. Other environmental entities may change over time, such as weather or addition of new roadways, which impact the state transition or dynamics of the environment. The state changes (i.e., changes in state) are modeled as part of the world model 326 and can be readily updated to keep the world model 326 in sync by replacement of old values with new values for the state parameters. The dynamic changes affect the transition model (state transition parameters (functions)) so may require re-estimation of the world model parameters. This can be done systematically using statistical tests to compare the current state transition distribution, such as repair time distributions, travel time estimates, etc., with the distribution observed in the field in the recent data. If a deviation is observed, then the distribution is updated in the world model 326 using the current distribution (statistics). Subsequent analysis is triggered to ensure that the reality gap is small with the updated models.

FIG. 8 shows an example workflow for monitoring of the state transition distributions. Given a known or actual action, observations are generated from the physical world 310 and the world model 326. An error is measured between the observations, which may be KPI values or monitored variables. When the error is greater than a threshold, then the new distribution is estimated based on recent historical data. The state transition model estimator 410 is used to generate the updates to the world model 326. This process continues until the error in observations is below a threshold level.

In act 210 of FIG. 2, a processor machine trains the AI. For gamification of act 212, the training uses the simulation so that the AI outputs actions to influence the world model 326. The machine training teaches the AI to generate outputs based on inputs. The outputs are recommended actions, and the inputs are measurements and/or observations.

The machine training is reinforcement learning. A policy (agent or bot) to control actions given inputs is trained using many training samples. The policy is trained to make the recommendations based on simulations from the world model 326. The fit or refined world model 326 is used to simulate the reaction of the service management system to a recommended change or a change in initial conditions. The KPI or other performance indicator(s) are used as rewards in the reinforcement training. The AI (e.g., policy) learns to provide the strategy in the gamification using the simulations from the world model 326.

With the world model 326 with sufficiently low reality gap in place, any of various reinforcement learning algorithms are used to train the agent. FIG. 5 shows an example agent training loop. The agent or policy 500 outputs actions in response to observations from the state estimator 324. The world model 326 provides measurements to the state estimator 324. The measurements are values resulting from the modeling of taking the action or other alteration of the world model 326. The world model 326 is used to calculate, derive, or output the performance indicators. The policy 500 is rewarded or not based on the rewards from the world model 326. Any period may be used for determining the rewards by the world model 326. The policy 500 receives rewards based on whether the service environment evolves favorably or not. The goal of the training process is to learn the policy 500 that maximizes future rewards. In the service management setting, this essentially implies the agent making observations of the customer as well employee locations, KPIs etc., taking actions such as changing field assignments, and receiving rewards based on how much the KPIs improve or degrade over time due to those actions.

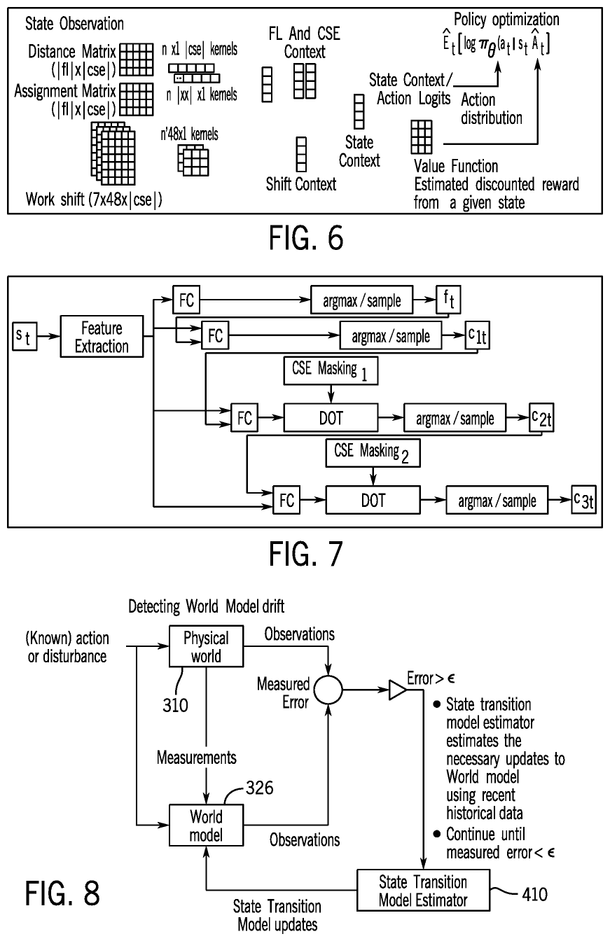

The policy is implemented as a neural network or another architecture. FIG. 6 shows an example AI-agent or policy 500 to recommend field assignments. The policy network is a deep network processing spatio-temporal, heterogenous data. Matrices are provided for distances, assignments, and work shifts. Other data may be used. Any number of convolutional layers and corresponding kernels to be learned connect the distance and assignment matrices to machine (functional location—FL) and technician (CSE) contexts, and any number of convolutional layers and corresponding kernels to be learned connect the work shift matrix to the shift context. The contexts connect to a state context, which feeds action logic and value functions. The action logic provides an action distribution, and the value function provides the reward given the state. The reward function may use episode rewards based on change in KPI and/or step rewards based on whether the technician is closer to the machine than other technicians. The training uses an optimization, such as proximal policy optimization.

FIG. 7 shows an example neural network implementation of the policy 500. The neural network receives state information at one or more feature extraction layers, which feed to fully connected (FC) layers. The FC layers output to a dot product (DOT) between the FC layers and the CSE mask (binary mask masking out a selected technician or technicians (CSE). The CSE masks may help avoid selecting a same CSE for each of the CSE assignments (primary, secondary, tertiary). Layers with technician masking and/or argmax (e.g., softmax) layers output a ranking or probability for different actions. The actions may feedback to FC layers, such as in a daisy chain so that determination of other actions are informed by prior action probabilities. The neural network is trained to provide probabilities of action dependencies (e.g., probability distributions showing combinations of actions that may result in highest rewards). Other neural network architectures may be used.

During training (optimization) of the policy 500, the AI is trained to make the recommendations for service by the service personnel of the machines. For example, the policy 500 is trained to make recommendations about the primary, secondary, and/or tertiary assignments of service personnel to various machines.

The training is based on simulations from the modeling of the service management system and based on rewards from one or more performance indicators. For example, the service times (e.g., period from service request to completion of service) are used as the or one of the rewards. Additionally, or alternatively, travel time is used as the or one of the rewards. The rewards are determined from the world model 326 reaction to actions. Actual past actions and physical world measurements and/or observations may be used for some of the training, such as including actual occurrences as well as simulated ones.

During the training, other information than the actions taken may be simulated. To train the policy to deal with different situations, the values of the state and/or transition parameters of the world model 326 may be varied or perturbed. Different actions may then be tested with the perturbed model 326. The variation may be stochastic, resulting in millions or billions of variations in the world model 326 and corresponding reactions to actions. For variation, values of parameters of the model are changed. State parameters and/or state transition parameters are varied. Where the parameter of the model is linked to or represented by a distribution, different samples may be used from the distribution. For the stochastic sampling, the distribution may be used to weight the sampling so that more common values are used more often in the simulations. The distribution itself may be varied, and then the perturbed distribution used for sampling. The reinforcement learning uses perturbation of the modeling of the service management system or environment to provide different initial conditions and/or state transitions. To be robust to variations in the real world, the policy 500 or agent is trained by simulating billions of scenarios generated with different initial conditions and/or perturbed state transition models.

The training relies on the rewards. In alternative, or additional, implementations, adversarial training is used. The policy 500 and an adversarial agent are trained together and/or in an interleaved fashion. The adversarial machine-learned agent is configured by past training to perturb values of parameters (e.g., state and/or transition) of the world model 326 in the simulations such that an adverse reward is received for the adversarial machine-learned agent. The adverse reward is for when the AI agent being trained fails to improve the rewards for itself in the reinforcement learning. The adversarial agent is rewarded for identifying situations where the policy 500 has little or no reward.

Despite simulating billions of scenarios, it may still be insufficient to cover the entire space of perturbations. To increase the breadth of situations for learning the policy 500, the policy 500 does not need to get exposed to all possible perturbations. The variation is focused on those perturbations that are likely to occur, such as by using sampling from the distribution. There may be scenarios in which the policy 500 may need to be exposed to multiple times to learn better policies. While the space of likely perturbations can be determined to a certain extend from historical data, the scenarios which may need to see multiple times are harder to determine. Adversarial perturbations, which is generally used to train robust deep learning models, is used to find those scenarios. The adversarial agent is trained to perturb the world model parameters such that the adversarial agent receives a reward when the original service agent (policy 500) fails to improve the KPIs.

Once trained, the resulting policy 500 may be used to make recommendations. The inputs (e.g., measurements and/or observations), such as current assignments, locations, training by type, and rating by type, for the physical world 310 are input to the policy 500, which outputs one or more recommended actions.

The trained policy 500 is stored. Copies may be distributed. A service manager may access a copy locally or remotely (e.g., in the cloud) for use by that service manager. The policy 500 or copies of the policy 500 are used for different regions by different service managers.

In act 214 of FIG. 2, a processor retrains the policy 500. The AI is updated or refined based on new information. The physical world 310 and/or fit of the world model 326 to the physical world 310 may be monitored to identify when refinement is needed. Alternatively, or additionally, a known change may trigger retraining. In other implementations, the retraining is on-going or periodic based on newly acquired data from the physical world 310.

In one implementation, the processor retrains the policy 500 of the AI when an actual distribution of a parameter of the model is a threshold different from a distribution or distributions used in the machine training. The AI agent or policy 500 may be continuously re-trained and adapted with new data from the physical world 310 because of environmental factors. The physical world 310 changes, and these changes may trigger updates to the world model 326. Since the agent is trained with massive perturbations to the world model 326, this does not necessarily imply that the agent's learned policy 500 needs to be updated. With the adversarial training, the likelihood of agent re-training is small.

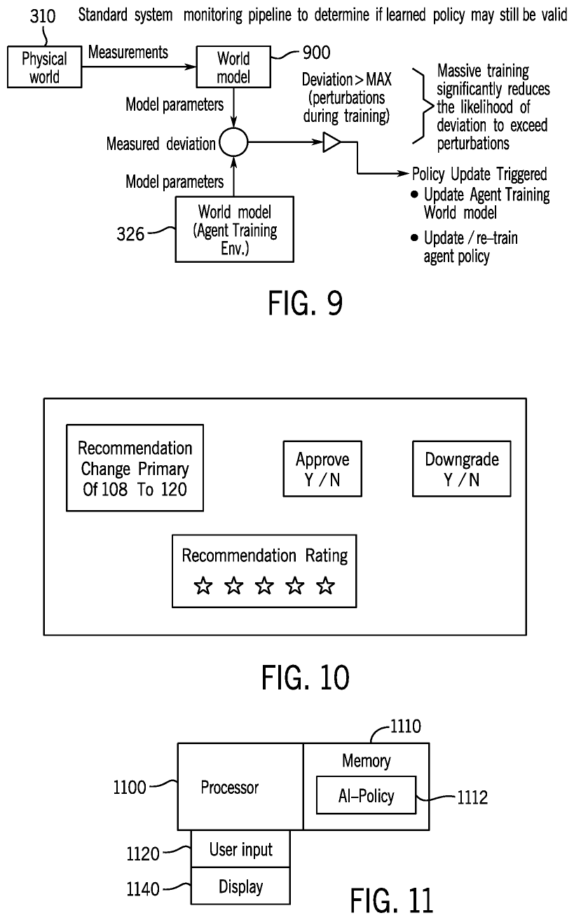

To ensure overall system robustness and relevance of recommendations, the changes are monitored. FIG. 9 shows a schematic diagram of an example policy update workflow. An update is triggered if sufficiently different. Instead of comparing the current world model parameters to the physical world measurements (see FIG. 8), the distribution observed in the field is compared with the extent of perturbations that the agent was trained on. A world model 900 is fit to the physical world 310, such as updating the parameters to include new measurements. The model parameters from the updated world model 900 and the world model 326 used to train the policy 500 are compared. If the deviation is larger than the perturbations considered during training, then re-training may be conducted by expanding the perturbation space of the world model 326 to include current field distributions and ensuring the new learned policy 500 is robust to the current distributions.

In another implementation, the processor retrains the policy 500 of the AI based on review results for the recommendations by a service manager. The AI agent may be continuously retrained and adapted with new data from the physical world 310 as a result of the service manager's post-recommendation actions or other environmental factors. Instead of automated adaptation of the agent based on observed behavior, explicit user feedback can be utilized to update the agent's policy 500. This can be done by presenting the recommendations via a user interface, such as shown in FIG. 10. The recommendations can be systematically reviewed as well as accepted or downgraded by the service manager. The recommendations may be rated. This approval, downgrade, and/or rating indicates whether the recommendation by the policy 500 is good or not. This information is used to adjust the rewards in retraining.

In an example implementation used herein, the AI agent is trained to present service managers with useful recommendations for service personnel to machine assignment priority. Additional AI agents may be trained similarly on other aspects of service management, such as shift assignment of personnel, dispatch of personnel, training or contract of personnel, and/or reassignment or reshaping of regions. A set of AI agents or policies is provided. The set may be organized in a hierarchical fashion, mimicking the structure of the service organization. Some policies may be trained to rely on output recommendations of other policies.

In act 220 of FIG. 2, the processor stores the policy 500 as trained by the machine training in one or more memories. The AI agent, including the policy 500 or as the policy 500, is stored. Copies may be stored in different locations or memories.

The stored policy 500 is used to make recommendations for service managers. The same or different processor than used for training applies the policy 500 to make recommendations given the service management system for the region for which the service manager is responsible.

FIG. 1, as another implementation, shows an example screenshot of an interface that presents recommendations to the service manager. For example, one recommendation is to change the primary technician for machine 108 to technician 120. The change is expected to improve the KPI over time as shown by the KPI graph. To facilitate better interaction, the interface concisely presents information associated with the recommendation, so the manager can efficiently review the information. To this end, for each recommendation, the interface may display how the KPIs are expected to evolve if no actions are taken vs how they evolve if the recommended actions are taken. In addition, for each recommendation, further information can be presented, such as the proposed recommendation reducing the required travel time and/or service time by a certain percentage.

A list of recommendations may be presented by the order of their impact. With multiple KPIs under consideration, it's not straightforward to always rank these recommendations. Individual recommendations or a hierarchy of recommendations may be presented.

The interface may adapt to the service manager so that different service managers may have different interfaces. The purpose of the AI agent is to make recommendations that would help the service managers achieve the KPI targets and/or to make the physical world KPIs improve. To lead to better KPI in the physical world, the interface may adapt to the manager's behavior to increase the likelihood of use of the AI agent. The interface may adapt the presentation of recommendations based on the frequency at which manager reviews the recommendation and/or time spent reviewing the recommendation. For instance, if a manager frequently reviews the recommendations and implements actions in the physical world based on these recommendations, then the interface uses the AI-agent to present additional recommendations frequently and helps the manager quickly navigate through problematic situations. If the frequency of the manager assessing these recommendations is small, then the agent may prioritize recommendations that are more risk-averse and likely to have higher long-term impact. Single, a fewer number, or less frequent recommendations that have greater impact may be presented to the service manager than if the manager is a high user of the recommendations.

FIG. 11 is a block diagram of one embodiment of a system for machine-learned model service assistance. The previously trained AI agent or policy 1112 is applied by the processor 1100 to make one or more recommendations. Due to previous gamification in training, the policy 1112 outputs recommendations more likely to improve KPI, such as the interface shown in FIG. 1. The system is for application of a learned policy 1112 to assist a service manager. In alternative embodiments, the system is used for training, implementing the method of FIG. 2.

The system includes a processor 1100, a memory 1110, a user input 1120, and a display 1140. The processor 1100, memory 1110, user input 1120, and display 1140 are part of a computer or workstation for the service manager. Alternatively, the processor 1100, memory 1110, user input 1120, and display 1140 are part of a server for remote access and recommendation output. In other embodiments, the processor 1100, memory 1110, user input 1120, and display 1140, are formed from multiple computers, such as a server implementing the processor 1100 and memory 1110 and a local computer implementing the user input 1120 and display 1140.

Additional, different, or fewer components may be provided. For example, a network or network connection is provided, such as for networking with a server or client computer. In another example, the user input 1120 is not provided.

The memory 1110 may be a graphics processing memory, a video random access memory, a random-access memory, system memory, cache memory, hard drive, optical media, magnetic media, flash drive, buffer, database, combinations thereof, or other now known or later developed memory device for storing data.

The memory 1110 stores the AI agent or policy 1112 of the machine-learned model. The policy 1112 was previously learned by reinforcement machine learning in a gamification using simulation of a service environment in combination with the reinforcement machine learning of the policy. The policy was learned using rewards based on one or more key performance indicators of the service environment. The gamification used simulation with a model fit to the service environment. The simulations were generated using perturbation of distributions and/or sampling of parameters of the model as fit to the service environment and resulting changes in performance indicators as rewards in the reinforcement machine learning. The past training results in a current policy 1112. Different training may result in different policies 1112. The policy 1112 was trained to provide recommendations for the service environment.

Where the memory 1110 is used for training, the memory 1110 may store the AI as well as the world model 326. Simulations, measurements, observations, rewards, and/or other information may be stored.

The memory 1110 or other memory is alternatively or additionally a non-transitory computer readable storage medium storing data representing instructions executable by the programmed processor 1100 or a processor implementing the AI agent or policy 1112. The instructions for implementing the processes, methods and/or techniques discussed herein are provided on non-transitory computer-readable storage media or memories, such as a cache, buffer, RAM, removable media, hard drive, or other computer readable storage media. Non-transitory computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code, and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The processor 1100 is a general processor, central processing unit, control processor, graphics processor, digital signal processor, three-dimensional rendering processor, application specific integrated circuit, field programmable gate array, artificial intelligence processor, digital circuit, analog circuit, combinations thereof, or other now known or later developed device for applying the AI agent or policy 1112. The processor 1100 is a single device or multiple devices operating in serial, parallel, or separately. The processor 1100 may be a main processor of a computer, such as a laptop or desktop computer, or may be a processor for handling some tasks in a larger system. The processor 1100 is configured by instructions, design, hardware, and/or software to perform the acts discussed herein.

The processor 1100 is configured to apply the AI agent or policy 1112 to make one or more recommendations. The processor 1100 is configured to input measurements from the service environment to the policy and to output a recommendation from the policy in response to the input of the measurements. Alternatively, or additionally, observations may be input to generate the output recommendation. More than one recommendation may be output. Probabilities corresponding to recommendations and/or expected performance indicator change may be output.

The processor 1100 may be configured to generate a graphic user interface (GUI) for input of feedback and/or implementation of a recommendation. The GUI includes one or both of the user input 1120 and the display 1140. The GUI provides for user interaction with the processor 1100. The interaction is for inputting information (e.g., selecting physical world files or measurements), for reviewing output information (e.g., viewing recommendations, KPI, and other information, and/or for providing feedback (see FIG. 10)).

The processor 1100 may be configured to adapt an interface based on interaction with the service manager. The processor 1100 is configured to adapt the display of the recommendation with a priority based on frequency of assessment of results by a service manager. Other adaptations may be used.

The user input 1120 is a keyboard, mouse, trackball, touch pad, buttons, sliders, combinations thereof, or other input device. The user input 1120 may be a touch screen of the display 1140. User interaction is received by the user input 1120, such as approval, downgrade, or ranking of one or more recommendations. Other user interaction may be received, such as for activating or implementing a recommendation. Interaction with a service management interface, such as shown in FIG. 1, may be provided. The user may select machines and/or personnel to see current assignments, parameters (e.g., rating, service time, qualifications, etc.), types, travel times, recommendation, performance indicators, or other service-related information.

The display 1140 is a monitor, LCD, projector, plasma display, CRT, printer, or other now known or later developed devise for outputting visual information. The display 1140 receives recommendations and/or images of service information for display. Graphics, text, quantities, spatial distribution, or other information from the processor 1100, memory 1110, or machine-learned agent or policy 1112 may be displayed.

The display 1140 is configured by the processor and/or display plane to display the recommendation from the policy. The display of the recommendation may include display of a value of the key performance indicator with no change/action and a value of the key performance indicator when the recommendation is followed. The display may include display of an expected value of the key performance indicator given the recommendation and a period for the expected value (e.g., KPI over time).

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for machine training an artificial intelligence to make recommendations in a service management system, the method comprising:
modeling the service management system, the modeling being a model including machines, locations of the machines, service personnel, locations of the service personnel, and service times;
machine training, by a processor, the artificial intelligence with reinforcement learning, the artificial intelligence being trained to make the recommendations for service by the service personnel of the machines based on simulations from the modeling of the service system and based on rewards from a performance indicator from the service times; and
storing a policy of the artificial intelligence as trained by the machine training.

2. The method of claim 1, wherein modeling comprises modeling with a distribution of the service times based, at least in part, on travel times, and wherein machine training comprises simulating using different samples from the distribution for the simulations and/or variance of the distribution.

3. The method of claim 1, wherein machine training comprises machine training with an adversarial machine-learned agent configured by past training to perturb values of parameters of the model in the simulations such that an adverse reward is received for the adversarial machine-learned agent where the artificial intelligence fails to improve the rewards for the artificial intelligence.

4. The method of claim 1, wherein modeling comprises representing the service management system as a random process defined over states of the machines, locations of the machines, service personnel, locations of the service personnel, the service times, service personnel shifts, and service agreement information with state transition functions defining probabilities of change in the states.

5. The method of claim 4, wherein modeling comprises refining the states and the state transition functions based on matching observations from the modeling of the service management system to observations from the service management system.

6. The method of claim 5, wherein refining comprises refining based on actions and resulting values of the performance indicator.

7. The method of claim 1, wherein machine training comprises estimating states, taking actions, and receiving the rewards based on the simulations.

8. The method of claim 1, wherein machine training comprises the reinforcement learning using perturbation of the modeling in the simulations, the perturbations being for different initial conditions and/or state transitions.

9. The method of claim 1, further comprising updating the model with statistical testing of the service times and/or other parameters of the model.

10. The method of claim 1, further comprising re-training the policy of the artificial intelligence when an actual distribution of a parameter of the model is a threshold difference from a distribution or distributions used in the machine training.

11. The method of claim 1, further comprising re-training the policy of the artificial intelligence based on review results for the recommendations by a service manager.

12. A method for machine training an artificial intelligence to make recommendations in a service management system, the method comprising:
modeling the service management system, the modeling using a model with state parameters and state transition parameters for the service management system;
machine training, by a processor, a policy with reinforcement learning, the policy being trained to make the recommendations based on simulations using the model, the simulations perturbing sampling of distributions and/or selection of distributions for the state parameters and/or the state transition parameters; and
storing the policy as trained by the machine training.

13. The method of claim 12, wherein modeling comprises modeling with the state parameters comprising including machines, locations of the machines, service personnel, locations of the service personnel and the state transition parameters comprising service times and travel times, and wherein machine training comprises the reinforcement learning using rewards from performance indicators for the service times and the travel times.

14. The method of claim 12, wherein machine training comprises machine training with an adversarial machine-learned agent configured by past training to perturb values of the state parameters and/or the state transition parameters of the model in the simulations such that an adverse reward is received where the policy fails to improve rewards of the reinforcement learning.

15. The method of claim 12, further comprising updating the model with statistical testing the state transition parameters of the model and/or with replacement of values of the state parameters.

16. A system for machine-learned model service assistance, the system comprising:
a memory configured to store a policy of the machine-learned model, the policy having been learned by reinforcement machine learning in a gamification using simulation of a service environment in combination with the reinforcement machine learning of the policy;
a processor configured to input measurements from the service environment to the policy and to output a recommendation from the policy in response to the input of the measurements; and
a display configured to display the recommendation from the policy.

17. The system of claim 16, wherein the policy was learned using rewards based on a key performance indicator of the service environment, and wherein the display of the recommendation includes an expected value of the key performance indicator given the recommendation and a period for the expected value.

18. The system of claim 16, wherein the policy was learned using rewards based on a key performance indicator of the service environment, and wherein the display of the recommendation includes display of a value of the key performance indicator with no change and a value of the key performance indicator when the recommendation is followed.

19. The system of claim 16, wherein the processor is configured to adapt the display of the recommendation with a priority based on frequency of assessment of results by a service manager.

20. The system of claim 16, wherein the gamification comprised use of the simulation with a model fit to the service environment, the simulations having used perturbation of distributions and/or sampling of parameters of the model as fit to the service environment and resulting changes in performance indicators as rewards in the reinforcement machine learning.
